(19) United States
(12) Patent Application Publication
(10) Pub. No.: US 2026/0277588 A1
(43) Pub. Date: Sep. 17, 2026

(54) ENGINEERING TOOL, PROGRAM EDITING METHOD, AND NON-TRANSITORY COMPUTER-READABLE STORAGE MEDIUM

(71) Applicant: Keyence Corporation, Osaka (JP)

(72) Inventor: Masato FUJIMURA, Osaka (JP)

(73) Assignee: Keyence Corporation, Osaka (JP)

(21) Appl. No.: 19/466,645

(22) Filed: Feb. 2, 2026

(30) Foreign Application Priority Data
Mar. 11, 2025 (JP) 2025-038008

(51) Int. Cl. G06F 8/65; G05B 19/05

(52) U.S. Cl. CPC G06F 8/65; G05B 19/05

(57) ABSTRACT

A user program of a programmable logic controller can be easily edited. An input assisting unit of an engineering tool determines whether an input text is a command or an operand, and if the text is an operand, presents an operand candidate corresponding to the text based on the text, a built-in information stored in a memory, and setting information, related to structure member or array variable, set by a user input. Each information is information indicating a correspondence relationship between a program element used for a user program and a comment corresponding to the program element. The input assisting unit presents the corresponding structure member or array variable as an operand candidate when any one of a variable name of a structure type and a comment associated with the structure member or array variable is received as the text.

### CROSS-REFERENCE TO RELATED APPLICATIONS

The present application claims foreign priority based on Japanese Patent Application No. 2025-038008, filed Mar. 11, 2025, the contents of which are incorporated herein by reference.

### BACKGROUND OF THE INVENTION

### 1. TECHNICAL FIELD

The present invention relates to an engineering tool, a program editing method, and a non-transitory computer-readable storage medium for editing a user program of a programmable logic controller.

### 2. DESCRIPTION OF THE RELATED ART

Japanese Patent No. 4420210 discloses a program development support device that creates a program for a programmable logic controller, the program development support device including: a variable table including a variable name, an internal memory address, and an I/O comment; a variable name display section that sets at least one type of the variable name, the internal memory address, and the I/O comment in the variable table as a search target, and displays a list of operand candidates when an operand of a command word constituting the program is input; and a variable name designation section that designates a desired variable name from variable names displayed by the variable name display section.

The device described in Japanese Patent No. 4420210 displays a list of a variable names and I/O comments as operand candidates when some of the variable names and the I/O comments is received as text.

However, when the user gives a comment to a structure member defined for a variable of a structure type or an array variable, even if a list of variable names and I/O comments is displayed as operand candidates as in Japanese Patent No. 4420210, the user cannot specify a desired structure member or array variable, and it is difficult to edit the user program.

### SUMMARY OF THE INVENTION

An object of the present invention is to provide an engineering tool, a program editing method, and a computer program capable of easily editing a user program of a programmable logic controller.

An engineering tool according to the present invention is an engineering tool for editing a user program of a programmable logic controller, including: a memory that stores predetermined built-in information indicating a correspondence relationship between a program element used for the user program and a natural language name corresponding to the program element; a setting unit that stores, in the memory, setting information set by a user, indicating a correspondence relationship between a program element at least partially including a structure member or an array variable used for the user program and a natural language name corresponding to the program element; a receiving unit that receives a text for editing the user program; and an input assisting unit that determines whether the text received by the receiving unit is a command or an operand, presents an operand candidate corresponding to the text based on the text, the built-in information, and the setting information when the text is an operand, and reflects an operand candidate selected from among presented operand candidates in the user program, in which the input assisting unit presents a corresponding structure member or array variable as the operand candidate in a case where any one of a variable name of a structure type and a natural language name associated with a structure member or array variable is received as the text.

A program editing method according to the present invention is a program editing method for editing a user program of a programmable logic controller, the program editing method including: a setting step of setting, in a memory that stores predetermined built-in information indicating a correspondence relationship between a program element used for the user program and a natural language name corresponding to the program element, setting information set by a user, indicating a correspondence relationship between a program element at least partially including a structure member or an array variable used for the user program and a natural language name corresponding to the program element; a receiving step of receiving a text for editing the user program; and an input assisting step of determining whether the text received in the receiving step is a command or an operand, presenting an operand candidate corresponding to the text based on the text, the built-in information, and the setting information when the text is an operand, and reflecting an operand candidate selected from among presented operand candidates in the user program, in which in the input assisting step, a corresponding structure member or array variable is presented as the operand candidate in a case where any one of a variable name of a structure type and a natural language name associated with a structure member or array variable is received in the receiving step as the text.

A computer program according to the present invention causes an engineering tool for editing a user program of a programmable logic controller, the engineering tool including a memory that stores predetermined built-in information indicating a correspondence relationship between a program element used for the user program and a natural language name corresponding to the program element, to function as: a setting section that stores, in the memory, setting information set by a user, indicating a correspondence relationship between a program element at least partially including a structure member or an array variable used for the user program and a natural language name corresponding to the program element; a receiving section that receives a text for editing the user program; and an input assisting section that determines whether the text received by the receiving section is a command or an operand, presents an operand candidate corresponding to the text based on the text, the built-in information, and the setting information when the text is an operand, and reflects an operand candidate selected from among presented operand candidates in the user program, in which the input assisting section presents a corresponding structure member or array variable as the operand candidate in a case where any one of a variable name of a structure type and a natural language name associated with a structure member or array variable is received as the text.

According to the engineering tool of the present invention, the input assisting unit presents the corresponding structure member or array variable as the operand candidate when any one of the variable name of the structure type and the natural language name associated with the structure member or the array variable is received as the text. As a result, the user can specify a desired structure member or array variable from the operand candidates, and can easily edit the user program of the programmable logic controller. Also in the program editing method and the computer program of the present invention, the above-described effects can be obtained by having the same specific matters as those of the engineering tool of the present invention.

### BRIEF DESCRIPTION OF THE DRAWINGS

FIG. 1 is a schematic diagram illustrating a control system including an engineering tool according to an embodiment of the present invention;

FIG. 2 is a block diagram illustrating an electrical configuration of a programmable logic controller connected to the engineering tool of FIG. 1;

FIG. 3 is a graph illustrating a relationship between a detected temperature value and time detected by a temperature input unit connected to the programmable logic controller of FIG. 2 and on/off of a relay;

FIG. 4 is a block diagram illustrating an electrical configuration of the engineering tool of FIG. 1;

FIG. 5 is a functional block diagram illustrating that an input assisting unit of a processor generates input assisting information based on built-in information and setting information in a memory in the engineering tool of FIG. 1;

FIG. 6 is a flowchart illustrating a flow in which the input assisting unit updates the input assisting information according to a change in the setting information in the engineering tool of FIG. 1;

FIG. 7 is a functional block diagram illustrating that the input assisting unit of the processor presents a candidate based on input assisting information in a memory and a text received via an operation unit in the engineering tool of FIG. 1;

FIG. 8 is a flowchart illustrating a flow in which the input assisting unit presents a candidate based on input assisting information and a text and reflects the selected candidate in a user program in the engineering tool of FIG. 1;

FIG. 9 is a schematic diagram illustrating a plurality of sensors which are connection devices connected to a communication unit of the programmable logic controller of FIG. 1;

FIG. 10 is a schematic diagram illustrating a correspondence relationship between array variables and comments corresponding to the plurality of sensors in FIG. 9;

FIG. 11 is a schematic diagram illustrating an example of a screen displayed on a display unit connected to the engineering tool of FIG. 1, in which array variables and comments of FIG. 10 are presented as candidates corresponding to an input text;

FIG. 12 is a schematic diagram illustrating a situation in which a default comment associated in advance with each of a plurality of structure members is stored as setting information in a structure defined by the engineering tool in FIG. 1 for a servo motor system connected to a motion unit of the programmable logic controller in FIG. 1;

FIG. 13 is a schematic diagram illustrating a situation in which a default comment associated in advance with each of a plurality of structure members is stored as setting information in a structure defined by the engineering tool in FIG. 1 and is changed according to a user's input for the temperature input unit connected to the communication unit of the programmable logic controller in FIG. 1;

FIG. 14 is a schematic diagram illustrating an example of a screen displayed on the display unit connected to the engineering tool of FIG. 1, in which structure members and comments of FIG. 13 are presented as candidates corresponding to an input text; and

FIG. 15 is a schematic diagram illustrating an example of a screen displayed on the display unit connected to the engineering tool of FIG. 1, in which a setting value of a sensor is written in response to selection of a candidate presented in FIG. 14.

### DETAILED DESCRIPTION

### Embodiment

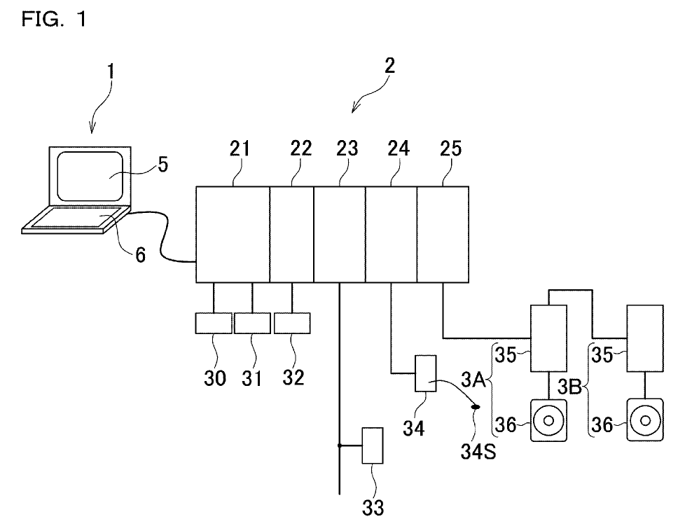

As illustrated in FIG. 1, an engineering tool 1 according to an embodiment of the present invention is communicably connected to a programmable logic controller (hereinafter, it is referred to as "PLC") 2 via a communication line such as a communication cable or a network. The engineering tool 1 is a device for editing a user program of the PLC 2, and includes a personal computer or the like. The user program edited in the engineering tool 1 is transmitted to the PLC 2 via the communication line. The user program may be edited using an arbitrary language such as a ladder language, a graphical programming language, or a C language.

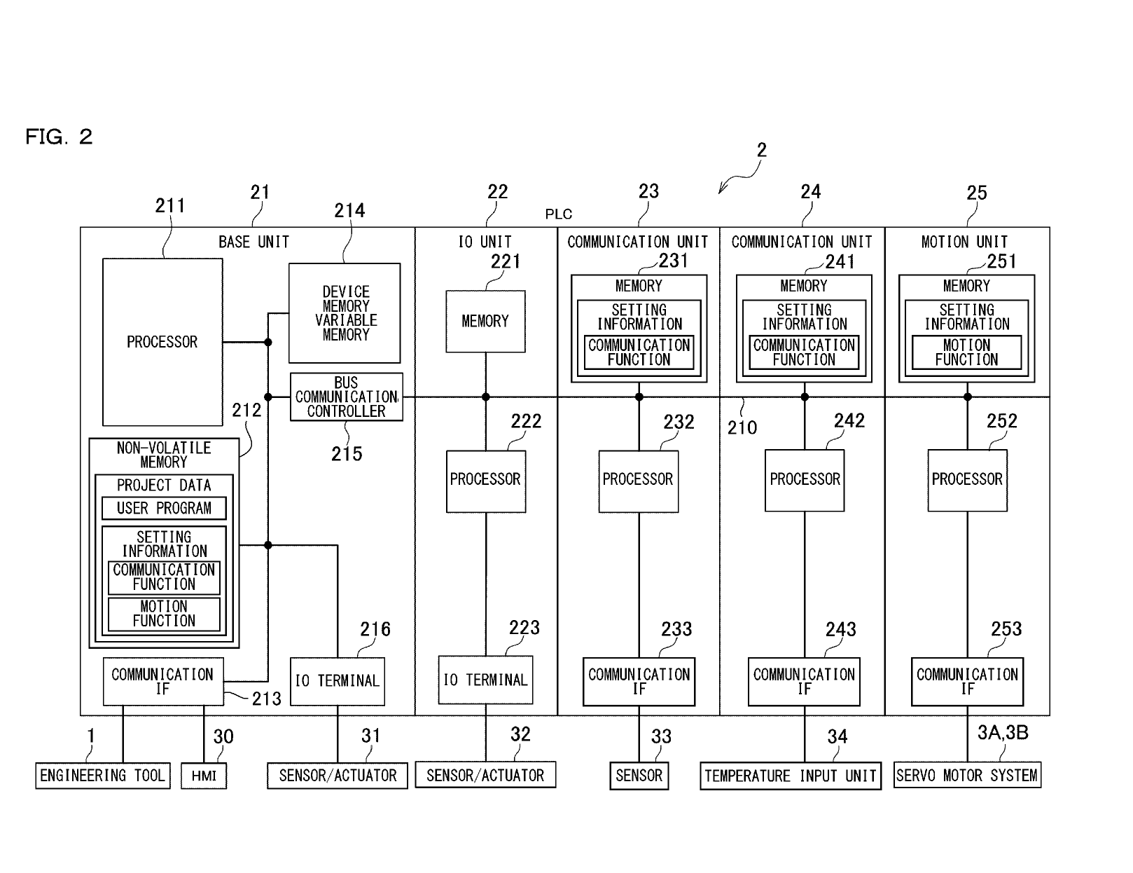

The PLC 2 includes a base unit 21, an IO unit 22, a communication unit 23, a communication unit 24, and a motion unit 25. The IO unit 22, the communication unit 23, the communication unit 24, and the motion unit 25 are extension units, and are electrically connected to the base unit 21 via an extension bus 210 as illustrated in FIG. 2.

The extension unit may be integrally fixed to the base unit 21, or may be disposed independently of the base unit 21. The number of extension units is four in the present embodiment, but can be arbitrarily changed.

The base unit 21 includes a plurality of elements including a processor 211, a non-volatile memory 212, a communication interface 213, a memory 214 including a device memory and a variable memory, a bus communication controller 215, and an IO terminal 216. These elements are electrically connected to each other via an internal bus.

The communication interface 213 is communicably connected to the engineering tool 1 and a HMI 30. The base unit 21 receives project data from the engineering tool 1 via the communication interface 213. The project data includes setting information of a communication function and a motion function in addition to the user program. The project data received from the engineering tool 1 is stored in the non-volatile memory 212.

The IO terminal 216 is electrically connected to a connection device 31 including a sensor or an actuator. The base unit 21 receives a detection signal from the connection device 31 including a sensor via the IO terminal 216, and transmits a control signal to the connection device 31 including an actuator.

According to the project data stored in the non-volatile memory 212, the processor 211 transmits a control signal to the connection device 31 including an actuator via the IO terminal 216, and transmits a command to the units 22 to 25 which are extension units via the extension bus 210.

The IO unit 22 includes a memory 221, a processor 222, and an IO terminal 223. The IO terminal 223 is electrically connected to a connection device 32 including a sensor or an actuator. The IO unit 22 receives a detection signal from the connection device 32 including a sensor via the IO terminal 223. The processor 222 transmits a control signal to the connection device 32 including an actuator via the IO terminal 223 according to a command from the processor 211.

The communication unit 23 includes a memory 231, a processor 232, and a communication interface 233. The communication interface 233 is electrically connected to a connection device 33 including a sensor. The communication unit 23 receives a detection signal from the connection device 33 including a sensor via the communication interface 233. The memory 231 stores setting information of the communication function. The processor 232 transmits a signal to the connection device 33 including a sensor via the communication interface 233 according to a command from the processor 211.

The communication unit 24 includes a memory 241, a processor 242, and a communication interface 243. The communication interface 243 is electrically connected to a connection device 34 including a temperature input unit. The communication unit 24 receives a signal from the connection device 34 including a temperature input unit via the communication interface 243. The memory 241 stores setting information of the communication function. The processor 242 transmits a signal to the connection device 34 including a temperature input unit via the communication interface 243 according to a command from the processor 211.

As illustrated in FIG. 1, the connection device 34 including a temperature input unit is electrically connected to a temperature sensor 34S. The connection device 34 converts the analog signal received from the temperature sensor 34S into a digital signal and transmits the digital signal to the communication unit 24. The connection device 34 transmits not only the digital signal indicating the temperature but also an alarm signal to the communication unit 24.

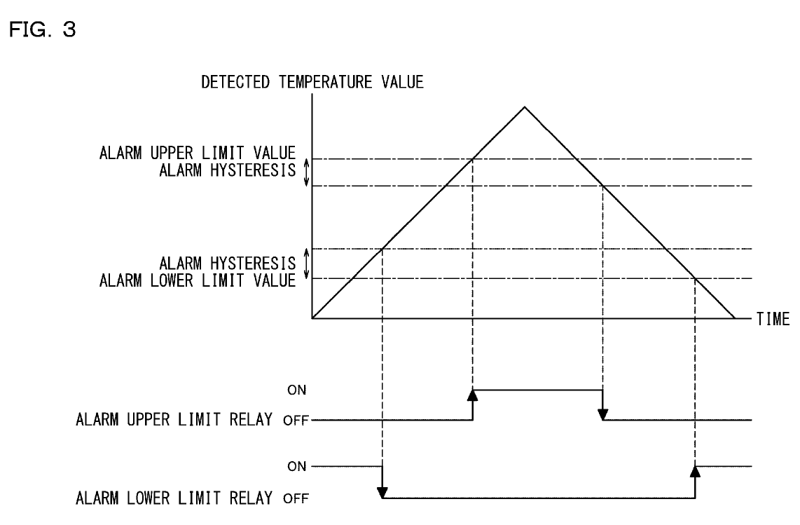

Specifically, as illustrated in FIG. 3, when the detected temperature value exceeds an alarm upper limit value and when the detected temperature value falls below an alarm lower limit value, the relay is turned on by the hysteresis control, and an alarm signal is transmitted from the connection device 34 to the communication unit 24. The detected temperature value is a temperature value based on a signal received from the temperature sensor 34S. The alarm upper limit value, the alarm lower limit value, and the alarm hysteresis value are stored in the memory 241 as setting information. These values may be set as initial settings or may be changed by a user program.

As illustrated in FIG. 2, the motion unit 25 includes a memory 251, a processor 252, and a communication interface 253. The communication interface 253 is electrically connected to servo motor systems 3A and 3B. The motion unit 25 receives signals from the servo motor systems 3A and 3B via the communication interface 253. The memory 251 stores setting information of a motion function. The processor 252 transmits a signal to the servo motor systems 3A and 3B via the communication interface 253 according to a command from the processor 211.

As illustrated in FIG. 1, the servo motor systems 3A and 3B each include a servo amplifier 35 and a servo motor 36. The servo amplifier 35 of the servo motor system 3A is communicably connected to the motion unit 25 via a communication cable. The servo amplifier 35 of the servo motor system 3B is communicably connected to the servo amplifier 35 of the servo motor system 3A via a communication cable. The servo amplifiers 35 of the servo motor systems 3A and 3B are daisy-chained via one communication cable. The servo amplifier 35 of the servo motor system 3B can communicate with the motion unit 25 via a communication cable. The communication cable is a cable compatible with an industrial network such as EtherCAT. Examples of the industrial network include EtherNet/IP, PROFINET, and MECHATROLINK-III in addition to EtherCAT.

In each of the servo motor systems 3A and 3B, the servo amplifier 35 supplies power to the servo motor 36, and controls the rotation amount and the like of the servo motor 36 according to a command from the processor 211 of the base unit 21. The servo motor 36 is driven according to a command from the servo amplifier 35. The servo amplifier 35 transmits the operating status of the servo amplifier 35 and the information acquired from the servo motor 36 to the base unit 21.

The connection devices 31 to 34 and the servo motor systems 3A and 3B may be installed in a factory or the like.

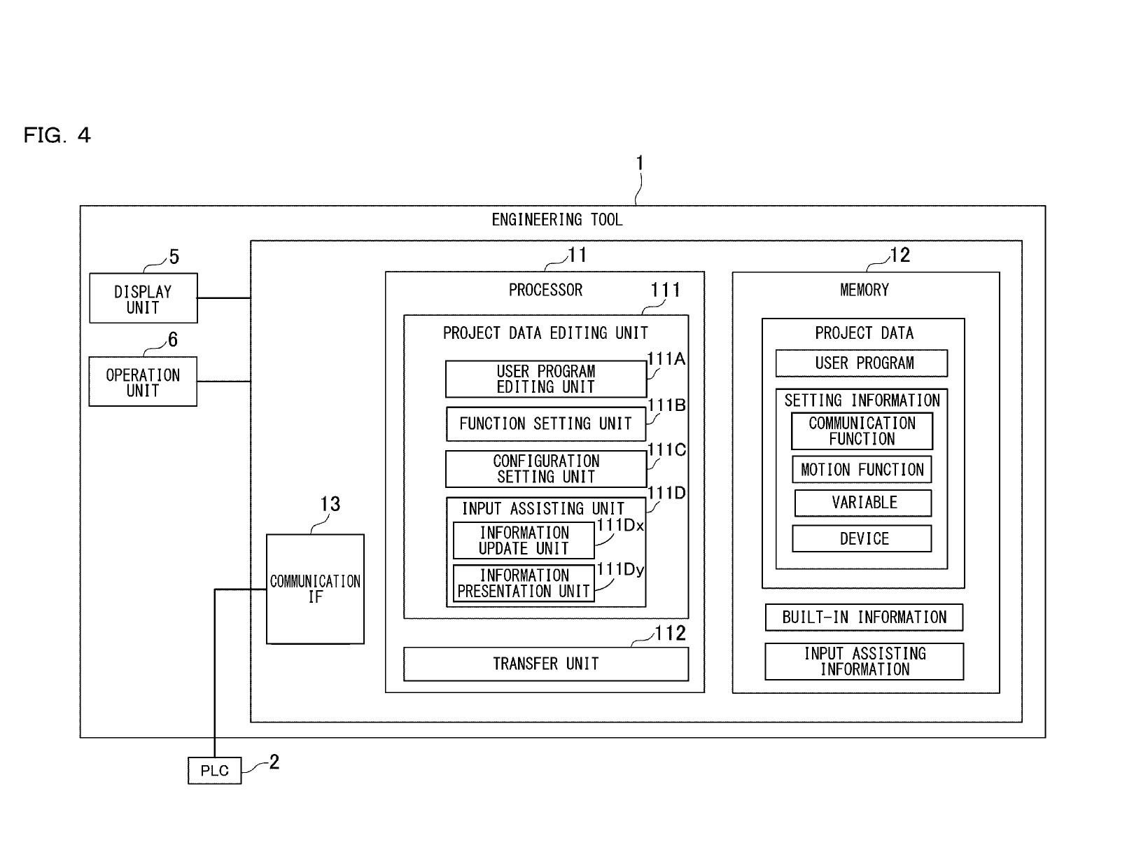

As illustrated in FIG. 4, the engineering tool 1 is electrically connected to a display unit 5 and an operation unit 6.

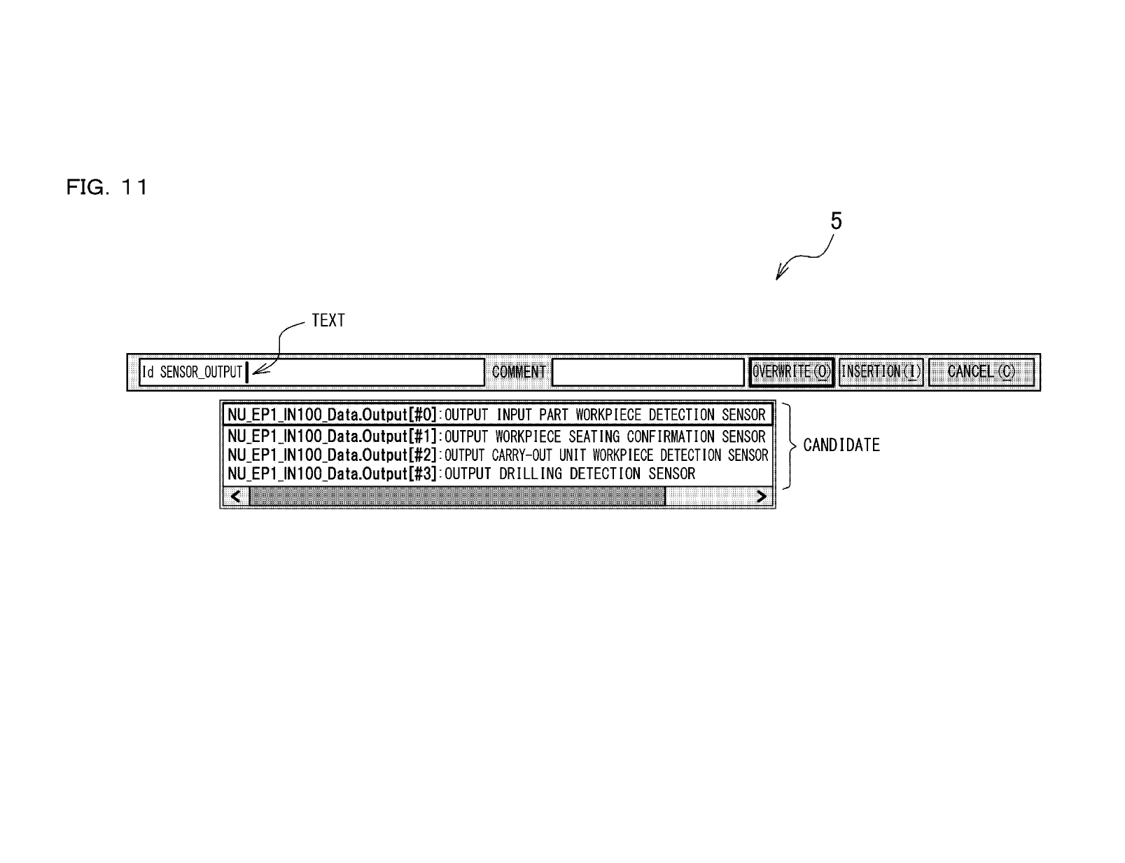

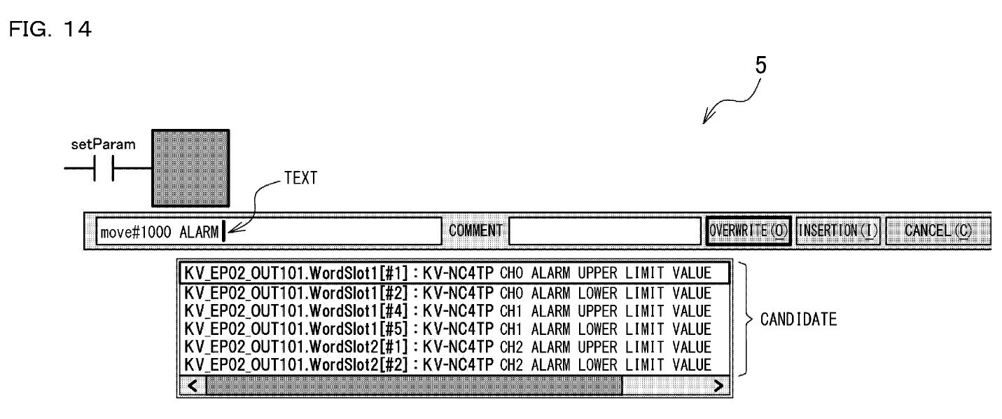

The display unit 5 is an element that displays a screen, and includes a CRT monitor, an LCD, or the like. The operation unit 6 is an element operable by the user, and includes a keyboard, a mouse, and the like. As illustrated in FIGS. 11 and 14, the user can input text for editing the user program by operating the operation unit 6 while viewing the screen displayed on the display unit 5.

The engineering tool 1 includes a processor 11, a memory 12, and a communication interface 13.

The communication interface 13 is communicably connected to an external device including the PLC 2 via a communication line. The engineering tool 1 transmits and receives data to and from an external device via the communication interface 13.

The processor 11 performs various software functions according to a computer program stored in the memory 12. The computer program corresponds to a "computer program" of the present invention, and is installed in the memory 12 via a recording medium such as a DVD or a CD-ROM, or a communication line.

The processor 11 includes a project data editing unit 111 and a transfer unit 112. The transfer unit 112 transfers the data generated by the project data editing unit 111 to the PLC 2 via the communication interface 13.

The project data editing unit 111 includes a user program editing unit 111A, a function setting unit 111B, a configuration setting unit 111C, and an input assisting unit 111D.

The user program editing unit 111A receives a text for editing the user program input via the operation unit 6, edits the user program based on the text, and stores the user program in the memory 12.

In addition, the user program editing unit 111A transmits the data received via the operation unit 6 to each of the units 111B, 111C, and 111D of the project data editing unit 111. The user program editing unit 111A corresponds to a "receiving unit" of the present invention, and functions as a "receiving section" of the present invention.

The configuration setting unit 111C stores the information about the configurations of the units 21 to 25 of the PLC 2 set by the user in the memory 12.

The function setting unit 111B stores setting information set by the user in the memory 12. The function setting unit 111B corresponds to a "setting unit" of the present invention, and functions as a "setting section" of the present invention. The processing by the function setting unit 111B corresponds to a "setting step" of the present invention.

The setting information includes setting information of a motion function, setting information of a communication function, setting information of a variable, setting information of a device, and the like.

The setting information about the communication function is information about the setting of the connection devices 31 to 34 and the servo motor systems 3A and 3B connected to the PLC 2, and includes information about the assignment of the communication data about the connection devices 31 to 34 and the servo motor systems 3A and 3B to devices and variables.

The setting information of the motion function is setting information related to motion control of the servo motor systems 3A and 3B connected to the motion unit 25.

The setting information of a variable is setting information related to a variable used in the user program, and includes information of a comment to be referred to when the user edits the user program in addition to information of a program element such as a variable name and a data type. Data types include a structure type and an array. In a case where the data type is the structure type, the setting information of the variable includes information of a comment for the structure member. In a case where the data type is an array, the setting information of the variable includes comment information for the array element.

The setting information of the device is information indicating a correspondence relationship between the device name and the comment corresponding to the device name.

The comment corresponds to "natural language name" of the present invention.

The memory 12 stores a user program and the setting information as project data. The memory 12 further stores built-in information and input assisting information. The memory 12 corresponds to a "memory" of the present invention.

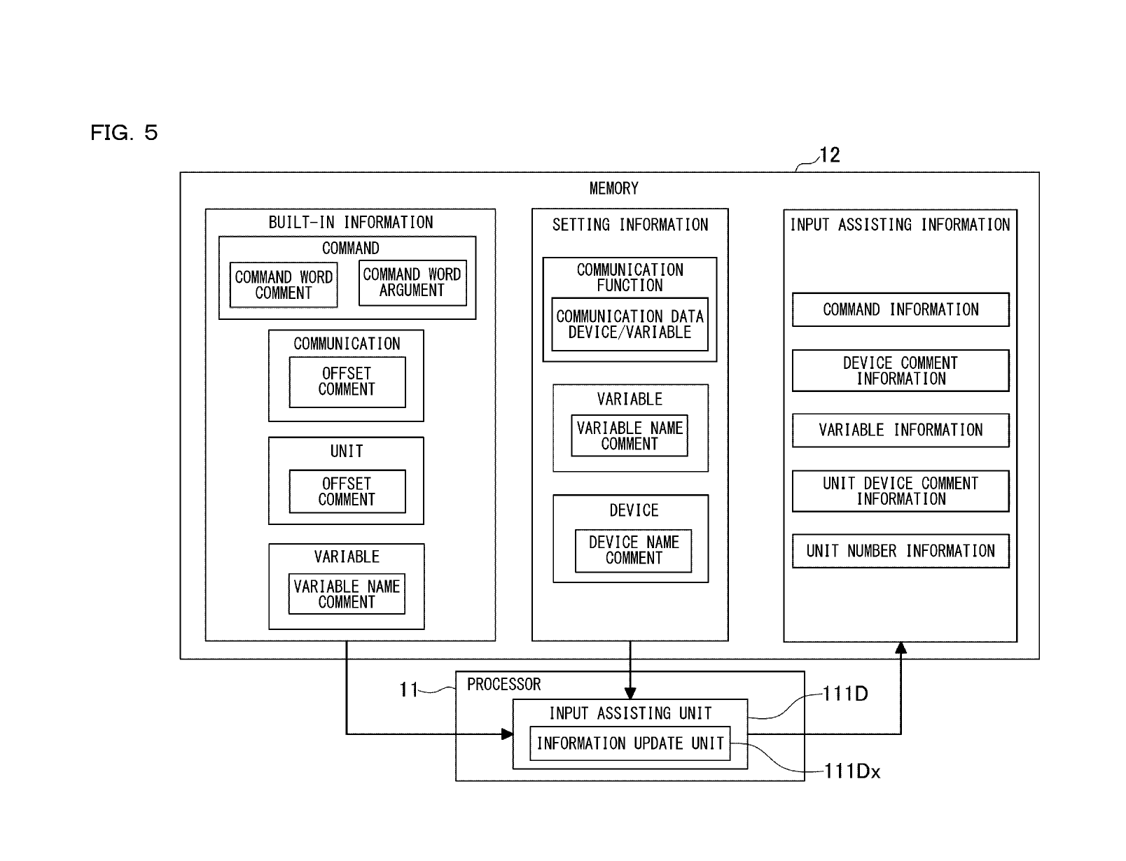

The built-in information is predetermined information, and includes built-in information of a command, built-in information of communication, built-in information of a unit, built-in information of a variable, and the like as illustrated in FIG. 5.

The built-in information of the command includes information indicating a correspondence relationship between the command word and the comment and information indicating a correspondence relationship between the command word and the argument.

The built-in information of the communication includes information indicating a correspondence relationship between an offset of data allocated to the communication data and a comment corresponding to the offset.

The built-in information of the unit includes information indicating a correspondence relationship between an offset of data allocated to the allocation device of the extension units 22 to 25 and a comment corresponding to the offset.

The built-in information of the variable includes information indicating a correspondence relationship between a variable name and a comment corresponding to the variable name.

The command word, the device name, and the variable name are included in a "program element" used for the user program. The variable name as the "program element" includes at least a part of a structure member or an array variable.

The input assisting information is generated by the input assisting unit 111D based on the built-in information and the setting information, and includes command information, device comment information, variable information, unit device comment information, unit number information, and the like. These pieces of information are information indicating a correspondence relationship between the comment and the data corresponding to the comment.

The input assisting information is updated according to the change of the setting information.

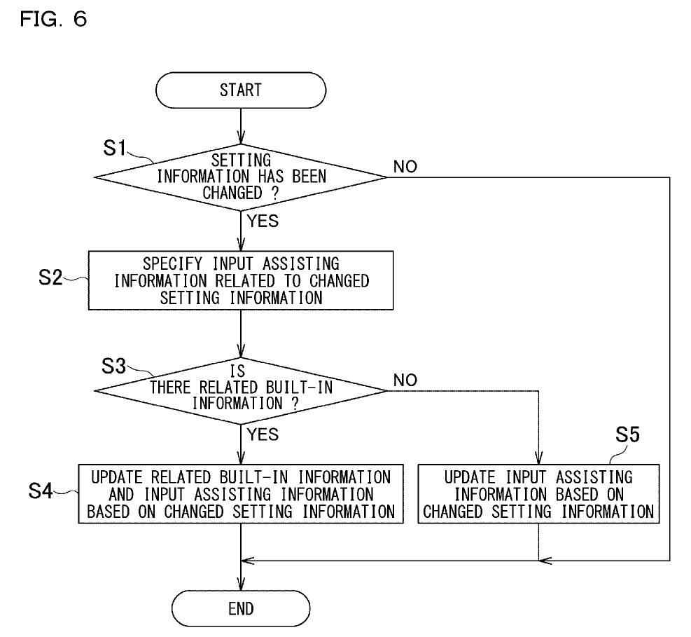

Specifically, as illustrated in FIG. 6, the processor 11 first determines whether setting information is newly stored in the memory 12 by the function setting unit 111B, that is, whether the setting information has been changed (S1).

When determining that the setting information is changed (S1: YES), the processor 11 specifies the input assisting information related to the changed setting information by an information update unit 111Dx of the input assisting unit 111D (S2).

After S2, the processor 11 determines whether or not there is built-in information related to the specified input assisting information by the information update unit 111Dx (S3).

When determining that there is the related built-in information (S3: YES), the processor 11 updates the related built-in information and the input assisting information based on the changed setting information by the information update unit 111Dx (S4).

On the other hand, when determining that there is no related built-in information (S3: NO), the processor 11 updates the input assisting information based on the changed setting information by the information update unit 111Dx (S5).

After S4 or S5, or when determining that the setting information is not changed (S1: NO), the processor 11 ends the routine.

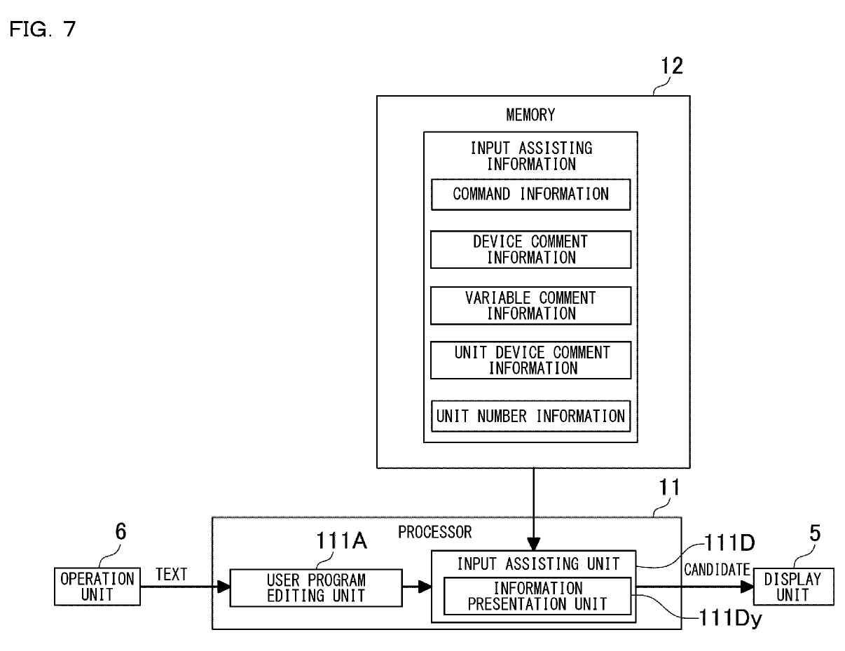

Further, as illustrated in FIG. 7, the input assisting unit 111D presents the candidates based on the input assisting information and the text received via the operation unit 6 by the information presentation unit 111Dy.

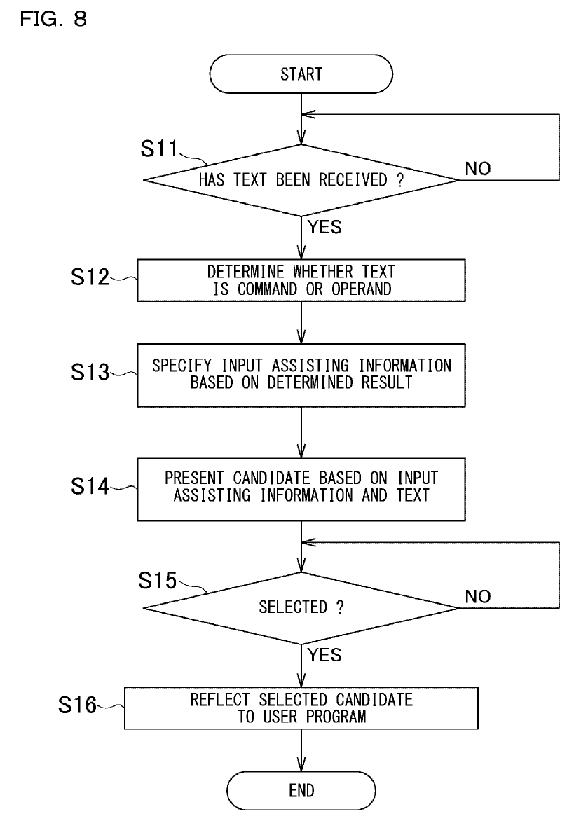

Specifically, as illustrated in FIG. 8, the processor 11 first determines whether the user program editing unit 111A has received the text through the operation unit 6 (S11). When determining not to accept the text (S11: NO), the processor 11 repeats the processing S11. The processing of receiving a text corresponds to the "receiving step" of the present invention.

When determining that the text is received (S11: YES), the processor 11 causes the information presentation unit 111Dy to determine whether the text is a command or an operand (S12).

After S12, the processor 11 specifies the input assisting information based on the result determined in S12 by the information presentation unit 111Dy (S13).

After S13, the processor 11 presents the candidate corresponding to the text based on the input assisting information specified in S13 and the text received in S11 by the information presentation unit 111Dy (S14). As described above with reference to FIG. 5, the input assisting information specified in S13 is based on the built-in information and the setting information.

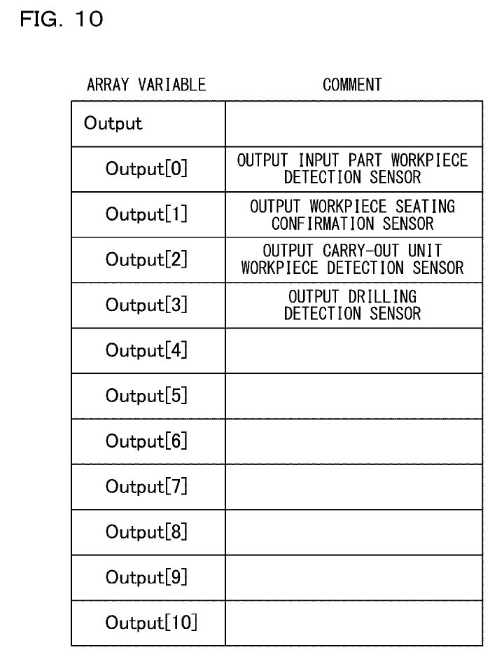

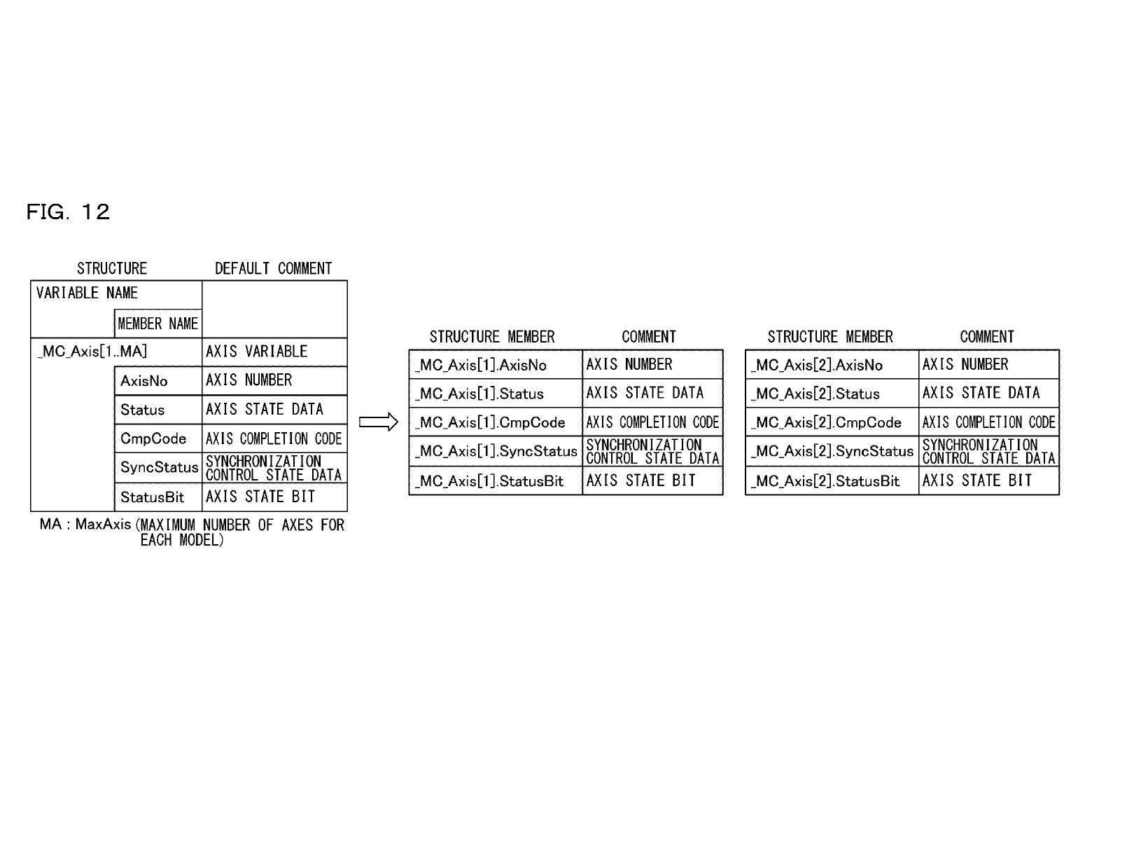

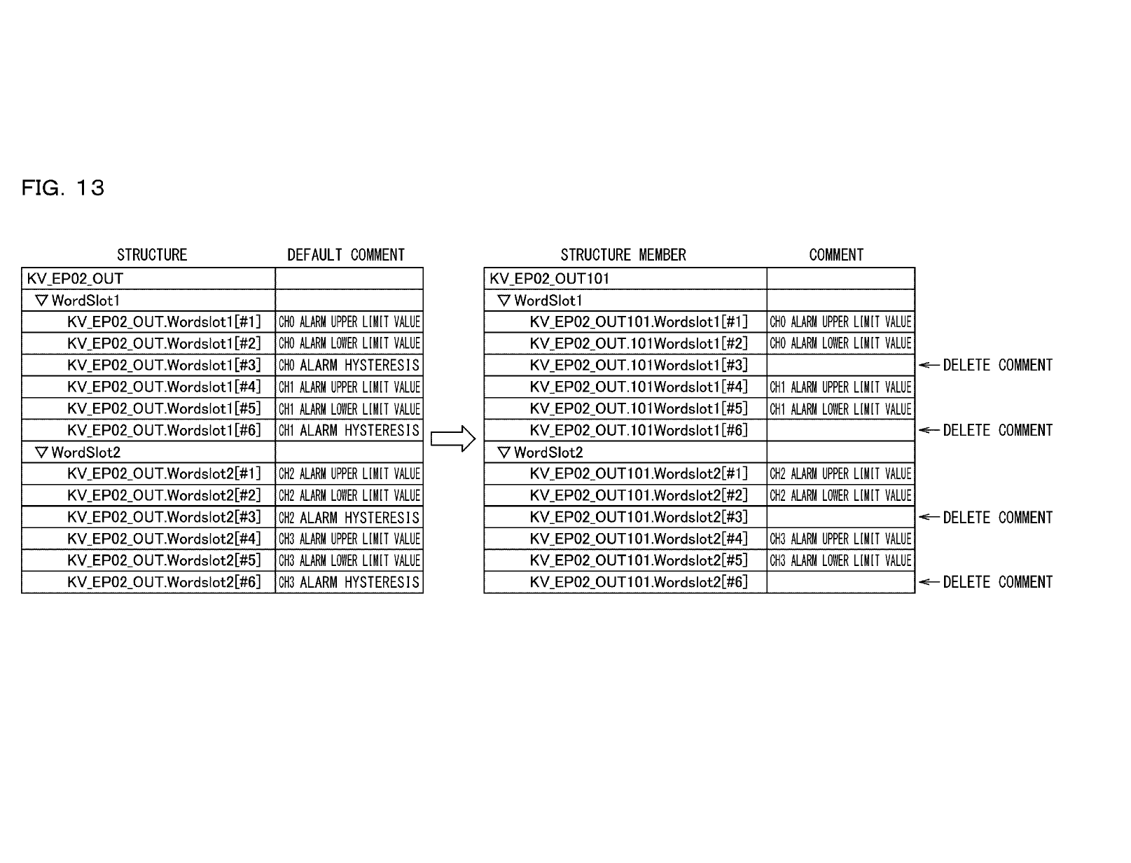

In S14, if the text is an operand, the information presentation unit 111Dy presents an operand candidate corresponding to the text. The information presentation unit 111Dy presents the corresponding structure member or array variable as the operand candidate in a case where any one of the variable name of the structure type (for example, "_MC_Axis" in FIG. 12) and the comment (for example, "shaft number" and "shaft state data" in FIG. 12 and "output input part workpiece detection sensor" in FIG. 10) associated with the structure member (for example, "AxisNo" or "Status" in FIG. 12) or the array variable (for example, "Output[0]" in FIG. 10) is received as the text. More specifically, the information presentation unit 111Dy presents, as operand candidates, a structure member or an array variable with which a comment is associated among a plurality of structure members or array variables (see FIGS. 13 and 14). Furthermore, in a case where both the structure member or the array variable and the device exist as operand candidates corresponding to the text, the information presentation unit 111Dy presents both the structure member or the array variable and the device as operand candidates.

The "shaft" refers to the servo motor 36, and the servo motor 36 is managed as a "shaft".

In S14, when the text is a command, the information presentation unit 111Dy presents a command candidate corresponding to the text.

After S14, the processor 11 determines whether any one of the presented candidates is selected by the user based on the input received by the user program editing unit 111A via the operation unit 6 (S15). When determining that no candidate is selected (S15: NO), the processor 11 repeats the processing S15.

When determining that the candidate is selected (S15: YES), the processor 11 causes the input assisting unit 111D to reflect the selected candidate in the user program (S16).

After S16, the processor 11 ends the routine.

The processing of S12 to S16 corresponds to the "input assisting step" of the present invention. The "program editing method" of the present invention is realized by the "input assisting step" and the "setting step" and the "receiving step".

The input assisting unit 111D that executes the processing of S12 to S16 functions as an "input assisting section" of the present invention.

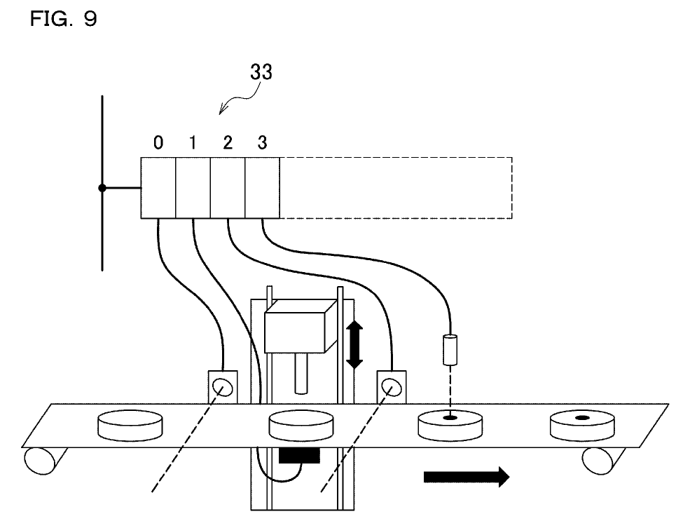

Here, a case where a plurality of sensors constituting the connection device 33 as illustrated in FIG. 9 are numbered as "0", "1", "2", and "3", and an array variable and a comment are associated with each of the sensors as illustrated in FIG. 10 will be described. Information indicating the correspondence relationship as illustrated in FIG. 10 is stored in the memory 12 as setting information of a variable.

In this case, as illustrated in FIG. 11, when the text "ld sensor _ output" is input in the search field on the screen displayed on the display unit 5, the part of "ld" is determined to be an LD command, and the part of "sensor _ output" is determined to be a comment of the operand corresponding to the LD command. Then, the array variables Output [0] to Output [3] in FIG. 10 and the comments are presented as operand candidates associated with the comments including both "sensor" _ and "output" among the operands corresponding to the LD command.

The text "ld sensor _ output" illustrated in FIG. 11 includes an LD command and an operand indicating the output of the sensor electrically connected to the PLC 2. In this case, the input assisting unit 111D presents a structure member or an array variable indicating that the output value of the sensor is read as a candidate.

The first character string "ld" of the text is discriminated as a command, and a command candidate including the name of the character string "ld" is presented. In a case where "ld sensor" is input as the text, the part of "ld" is determined to be an LD command, and the part of "sensor" is determined to be a comment of the operand corresponding to the LD command. Then, an operand candidate associated with the comment of "sensor" among the comments corresponding to the LD command is presented.

The function setting unit 111B can store the default comment associated in advance with the structure member in the memory 12 as the setting information of the variable in response to the user's input or automatically regardless of the user's input. The default comment is stored in the memory 12 as variable built-in information. For example, as illustrated in FIG. 12, in the structure defined for the servo motor systems 3A and 3B, the default comment associated in advance with each of the plurality of structure members is stored in the memory 12 as setting information of a variable according to the user's input. Furthermore, for example, in order to prevent the occurrence of noise due to capturing all the default comments, the function setting unit 111B may automatically capture only the comment effective when being captured among the default comments, and may capture the other comments according to the user's input.

The default comment illustrated in FIG. 12 is associated with each variable such as the axis number and the axis state data. The variables such as the axis number and the axis state data are associated with each of the plurality of servo motor systems 3A and 3B to be subjected to the motion control, and correspond to the "motion variable" of the present invention. The servo motor systems 3A and 3B correspond to a "drive unit" of the present invention.

Furthermore, the function setting unit 111B can store the default comment changed according to the user's input in the memory 12 as the built-in information of the variable. For example, as illustrated in FIG. 13, in the structure defined for the connection apparatus 34 including a temperature input unit, the default comment associated in advance with each of the plurality of structure members is stored in the memory 12 as the setting information of the variable according to the user's input, and the comment changed according to the user's input is further stored in the memory 12 as the setting information of the variable. In the example of FIG. 13, a part of the reflected comment is deleted.

In a case where the setting is performed as illustrated in FIG. 13, when the ladder program language is input and the text "move #1000 alarm" is input in the search field of the screen displayed on the display unit 5 as illustrated in FIG. 14, a portion of "move" is discriminated as a MOVE command, and a portion of "#1000 alarm" is discriminated as a comment of an operand corresponding to the MOVE command. Then, as operand candidates corresponding to the MOVE command, a structure member associated with the comment of "#1000 alarm" among the structure members in FIG. 13 and the comment are presented.

The text "move #1000 alarm" illustrated in FIG. 14 includes the MOVE command and the operand indicating the setting of the temperature input unit electrically connected to the PLC 2. In this case, the input assisting unit 111D presents, as a candidate, a structure member indicating that an alarm upper limit value or an alarm lower limit value, which is a set value of the temperature input unit, is to be written. The temperature input unit corresponds to a "sensor" of the present invention.

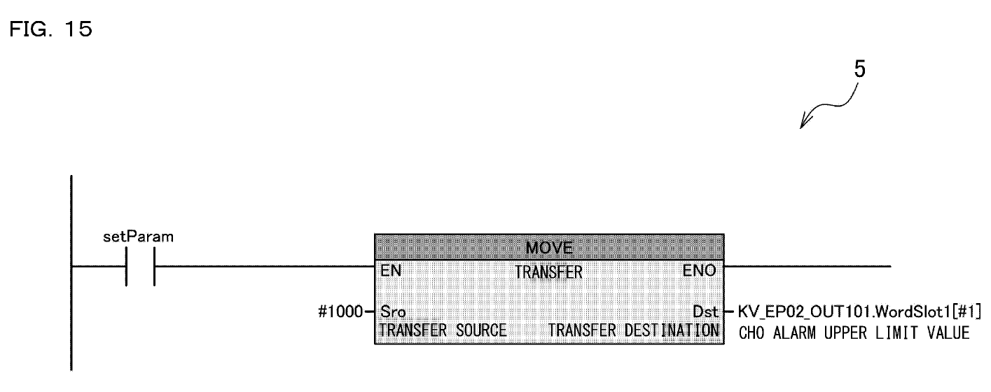

When the uppermost candidate in FIG. 14 is selected, as illustrated in FIG. 15, a set value 1000 is written to the alarm upper limit value which is the set value of the temperature input unit. As described above, the alarm upper limit value, the alarm lower limit value, and the alarm hysteresis value can be changed according to the user's input.

As described above, according to the engineering tool 1 of the present embodiment, the input assisting unit 111D presents the corresponding structure member or array variable as the operand candidate when any one of the variable name of the structure type and the comment associated with the structure member or array variable is received as the text. As a result, the user can specify a desired structure member or array variable from the operand candidates, and can easily edit the user program of the PLC 2. The program editing method and the computer program of the present embodiment also have the same specific matters as those of the engineering tool 1 of the present embodiment, thereby obtaining the above effects.

The input assisting unit 111D generates the input assisting information based on the built-in information and the setting information as illustrated in FIG. 5, and presents the operand candidates based on the input assisting information and the text as illustrated in FIG. 7. As a result, processing related to the presentation of the operand candidates can be efficiently executed.

As illustrated in FIG. 6, the input assisting unit 111D updates the input assisting information according to the change of the setting information. As a result, an appropriate candidate can be presented using the input assisting information based on the latest setting information.

When all structure members or array variables including a structure member or an array variable to which no comment is associated are presented as candidates, the number of candidates is large, and it is difficult for the user to specify a desired structure member or array variable. On the other hand, in the present embodiment, as illustrated in FIGS. 13 and 14, the input assisting unit 111D presents the structure member or the array variable associated with the comment as the operand candidate. As a result, since the number of candidates is narrowed down, the user can easily specify a desired structure member or array variable.

As illustrated in FIG. 12, the function setting unit 111B can store a default comment associated in advance with the structure member in the memory 12 as setting information of a variable. As a result, the default comment can be appropriately used, and convenience is improved.

As illustrated in FIG. 12, the default comment includes a comment associated with a motion variable (variables such as axis number and axis state data) which is a variable used for motion control. In this case, the default comment regarding the motion control can be appropriately used, and the convenience of program editing regarding the motion control is improved.

The motion variable (variables such as axis number and axis state data) is associated with each of the plurality of servo motor systems 3A and 3B which are motion control targets. As a result, the individual motion control of the plurality of servo motor systems 3A and 3B can be appropriately executed.

As illustrated in FIG. 13, the function setting unit 111B can store the default comment changed according to the user's input in the memory 12 as the built-in information of the variable. As a result, the default comment can be appropriately changed and used as desired by the user, and convenience is further improved.

The program element used in the user program includes a program element at least partially including a structure member or an array variable, and a program element including a device name. As a result, since both the program elements can be used, the degree of freedom in program editing is improved.

When both the structure member or the array variable and the device exist as the operand candidates corresponding to the input text, the input assisting unit 111D presents both the structure member or the array variable and the device as the operand candidates. As a result, the user can specify a desired variable from the candidates including not only the structure member or the array variable but also the device.

If the input text is a command, the input assisting unit 111D presents a command candidate corresponding to the text based on the text and the built-in information. As a result, the user can specify a desired command word from among the candidates for the command word, and can easily edit the user program.

The input assisting unit 111D further reflects a command candidate selected from the presented command candidates in the user program. As a result, editing of the user program can be effectively realized.

As illustrated in FIG. 11, when the input text includes the LD command and the operand indicating the output of the sensor electrically connected to the PLC 2, the input assisting unit 111D presents, as a candidate, a structure member or an array variable indicating that the output value of the sensor is read. As a result, the user can easily add control for reading the output value of the sensor to the user program.

As illustrated in FIG. 14, when the input text includes the MOVE command and the operand indicating the setting of the temperature input unit electrically connected to the PLC 2, the input assisting unit 111D presents the structure member or the array variable indicating that the setting value of the temperature input unit is written as a candidate. As a result, as illustrated in FIG. 15, the user can easily write the setting value of the sensor such as the temperature input unit in the user program.

### Modification

Although the preferred embodiments of the present invention have been described above, the present invention is not limited to the above-described embodiments, and various design changes can be made as long as they are described in the claims.

For example, in the above-described embodiment, as illustrated in FIGS. 11 and 14, the candidates are presented on the screen of the display unit 5, but the present invention is not limited thereto. The candidate may be presented by voice via a voice output unit such as a speaker.

The input assisting unit is not limited to generating the input assisting information based on the built-in information and the setting information and presenting the operand candidate based on the input assisting information and the text. The input assisting unit may present the operand candidate by an arbitrary method based on the text and the setting information.

The setting information may not be updated after being set once.

The setting unit may not store the default natural language name associated in advance with the structure member in the memory as the setting information.

The default natural language name may not include a name associated with a motion variable that is a variable used for motion control.

The motion variable is not limited to a motion variable associated with each of a plurality of drive units to be subjected to motion control, and may be a motion variable associated with any of the plurality of drive units to be subjected to motion control, for example.

The motion variable is not limited to the axis number, the axis state data, and the like exemplified in the above-described embodiment, and may be a servo parameter variable or the like. The servo parameter is a parameter for controlling the servo amplifier, and includes restriction information regarding a position, a speed, an acceleration, and the like, and tuning information such as a gain in motion control.

The default natural language name may be unchangeable in response to user input.

The program element according to the present invention is not limited to having both of a program element including at least a part of a structure member or an array variable and a program element including a device name, and may have only one of them. In addition, the program element according to the present invention does not have a program element including at least a part of a structure member or an array variable and a program element including a device name, and may have a program element other than the above.

When both the structure member or the array variable and the device exist as the operand candidates corresponding to the text received by the receiving unit, the input assisting unit is not limited to presenting both the structure member or the array variable and the device as the operand candidates, and may present one of the structure member or the array variable and the device, for example.

The input assisting unit may not present the command candidate when the text received by the receiving unit is a command.

In the above-described embodiment, the case where the text received by the receiving unit includes the LD command and the MOVE command has been exemplified, but the present invention is not limited thereto, and the input assisting unit may present various structure members or array variables as candidates based on the command indicated by the text received by the receiving unit and the operand.

The program element used in the user program according to the present invention can be arbitrarily set according to a device connected to the PLC.

The computer program according to the present invention can be distributed by being recorded in a removable recording medium such as a flexible disk or a fixed recording medium such as a hard disk, and can be distributed via a communication line.

What is claimed is:

1. An engineering tool for editing a user program of a programmable logic controller, comprising:
a memory that stores predetermined built-in information indicating a correspondence relationship between a program element used for the user program and a natural language name corresponding to the program element;
a setting unit that stores, in the memory, setting information set by a user, indicating a correspondence relationship between a program element at least partially including a structure member or an array variable used for the user program and a natural language name corresponding to the program element;
a receiving unit that receives a text for editing the user program; and
an input assisting unit that determines whether the text received by the receiving unit is a command or an operand, presents an operand candidate corresponding to the text based on the text, the built-in information, and the setting information when the text is an operand, and reflects an operand candidate selected from among presented operand candidates in the user program, wherein
the input assisting unit presents a corresponding structure member or array variable as the operand candidate in a case where any one of a variable name of a structure type and a natural language name associated with a structure member or array variable is received as the text.

2. The engineering tool according to claim 1, wherein the input assisting unit generates input assisting information based on the built-in information and the setting information, and presents the operand candidate based on the input assisting information and the text.

3. The engineering tool according to claim 2, wherein the input assisting unit updates the input assisting information according to a change in the setting information.

4. The engineering tool according to claim 1, wherein the input assisting unit presents a structure member or an array variable associated with the natural language name as the operand candidate.

5. The engineering tool according to claim 1, wherein the setting unit can store a default natural language name associated in advance with a structure member in the memory as the setting information.

6. The engineering tool according to claim 5, wherein the default natural language name includes a natural language name associated with a motion variable that is a variable used for motion control.

7. The engineering tool according to claim 6, wherein the motion variable is associated with each of a plurality of drive units to be subjected to the motion control.

8. The engineering tool according to claim 5, wherein the setting unit is capable of causing the memory to store, as the setting information, information obtained by changing the default natural language name in accordance with a user input.

9. The engineering tool according to claim 1, wherein the program element includes a program element at least partially including a structure member or an array variable, and a program element including a device name.

10. The engineering tool according to claim 9, wherein when both a structure member or an array variable and a device exist as operand candidates corresponding to the text, the input assisting unit presents both the structure member or the array variable and the device as operand candidates.

11. The engineering tool according to claim 1, wherein
the program element includes a program element at least partially including a structure member or an array variable, and a program element including a command word, and
the input assisting unit determines whether a text received by the receiving unit is a command or an operand, and presents a command candidate corresponding to the text based on the text and the built-in information when the text is a command.

12. The engineering tool according to claim 11, wherein the input assisting unit further reflects a command candidate selected from the presented command candidates in the user program.

13. The engineering tool according to claim 11, wherein when a text received by the receiving unit includes an LD command and an operand indicating an output of a sensor electrically connected to the programmable logic controller, the input assisting unit presents, as a candidate, a structure member or an array variable indicating that an output value of the sensor is read.

14. The engineering tool according to claim 11, wherein when a text received by the receiving unit includes a MOVE command and an operand indicating a setting of a sensor electrically connected to the programmable logic controller, the input assisting unit presents, as a candidate, a structure member or an array variable indicating that the setting value of the sensor is to be written.

15. A program editing method for editing a user program of a programmable logic controller, the program editing method comprising:
a setting step of setting, in a memory that stores predetermined built-in information indicating a correspondence relationship between a program element used for the user program and a natural language name corresponding to the program element, setting information set by a user, indicating a correspondence relationship between a program element at least partially including a structure member or an array variable used for the user program and a natural language name corresponding to the program element;
a receiving step of receiving a text for editing the user program; and
an input assisting step of determining whether the text received in the receiving step is a command or an operand, presenting an operand candidate corresponding to the text based on the text, the built-in information, and the setting information when the text is an operand, and reflecting an operand candidate selected from among presented operand candidates in the user program, wherein
in the input assisting step, a corresponding structure member or array variable is presented as the operand candidate in a case where any one of a variable name of a structure type and a natural language name associated with a structure member or array variable is received in the receiving step as the text.

16. A non-transitory computer-readable storage medium storing instructions that, when executed by a processor, cause a computer for editing a user program of a programmable logic controller to perform a process comprising:
a setting step of setting, in a memory that stores predetermined built-in information indicating a correspondence relationship between a program element used for the user program and a natural language name corresponding to the program element, setting information set by a user, indicating a correspondence relationship between a program element at least partially including a structure member or an array variable used for the user program and a natural language name corresponding to the program element;
a receiving step of receiving a text for editing the user program; and
an input assisting step of determining whether the text received in the receiving step is a command or an operand, presenting an operand candidate corresponding to the text based on the text, the built-in information, and the setting information when the text is an operand, and reflecting an operand candidate selected from among presented operand candidates in the user program, wherein
in the input assisting step, a corresponding structure member or array variable is presented as the operand candidate in a case where any one of a variable name of a structure type and a natural language name associated with a structure member or array variable is received in the receiving step as the text.
